(19) United States
(12) Patent Application Publication
(10) Pub. No.: US 2018/0350366 A1
(43) Pub. Date: Dec. 6, 2018

(54) SITUATION-BASED CONVERSATION INITIATING APPARATUS, SYSTEM, VEHICLE AND METHOD

(71) Applicants: Hyundai Motor Company, Seoul (KR); Kia Motors Corporation, Seoul (KR)

(72) Inventors: Sung Soo Park, Seoul (KR); Seong Soo Yae, Osan (KR); Hyun-woo Lee, Seongnam (KR)

(21) Appl. No.: 15/804,764

(22) Filed: Nov. 6, 2017

(30) Foreign Application Priority Data
May 30, 2017 (KR) 10-2017-0066535

(51) Int. Cl. G10L 15/22; G06N 5/04; G06N 99/00; G10L 15/06; G10L 15/30; G10L 13/00; B60R 16/037

(52) U.S. Cl. CPC G10L 15/22; G06N 5/046; G06N 99/005; G10L 15/063; G10L 2015/228; G10L 13/00; B60R 16/0373; G10L 2015/223; G10L 15/30

(57) ABSTRACT

A situation-based conversation initiating apparatus in a vehicle includes: a situation information collector including a plurality of sensors disposed within the vehicle configured to collect situation information; a processor configured to determine context data based on the situation information, determine a target operation based on the context data and a situation analysis model, and generate speaking content to be output based on the determined target operation; and an output device configured to visually or audibly output the speaking content.

### CROSS-REFERENCE TO RELATED APPLICATION

This application claims the benefit of priority to Korean Patent Application No. 10-2017-0066535, filed on May 30, 2017, the disclosure of which is incorporated by reference in its entirety as if fully set forth herein.

### BACKGROUND

### 1. Technical Field

Embodiments of the present disclosure relate generally to vehicular technologies and, more particularly, to a situation-based conversation initiating apparatus, system, vehicle, and method.

### 2. Discussion of Related Art

Many recent vehicles are equipped with voice recognition devices enabling a user such as a driver or a passenger to enter a command by voice. The voice recognition device may facilitate the user's handling of the vehicle or various devices installed in the vehicle, such as a navigation device, a broadcast receiver, a head unit, or the like.

### SUMMARY OF THE DISCLOSURE

The present disclosure provides a situation-based conversation initiating apparatus, system, vehicle, and method, which may analyze different kinds of data to detect a surrounding situation and start a conversation with the user based on the detected situation.

In accordance with embodiments of the present disclosure, the situation-based conversation initiating apparatus includes: a situation information collector including a plurality of sensors disposed within the vehicle configured to collect situation information; a processor configured to determine context data based on the situation information, determine a target operation based on the context data and a situation analysis model, and generate speaking content to be output based on the determined target operation; and an output device configured to visually or audibly output the speaking content.

The processor may be configured to perform learning based on a user's usage history or a history of prior target operations, and create the situation analysis model based on a result of the learning.

The processor may be configured to perform at least one of rule-based learning and model-based learning and create the situation analysis model based on a result of the at least one of rule-based learning and model-based learning.

The situation information collector may be configured to collect a plurality of pieces of situation information, and the processor may be configured to extract at least two correlated pieces of context data among the plurality of pieces of situation information, and determine the target operation based on the at least two pieces of context data and the situation analysis model.

The processor may be configured to determine an operation scenario of an operation entity corresponding to the target operation based on the determined target operation.

The operation entity may include at least one application, and the processor may be configured to execute the at least one application and change a setting of the at least one application based on an operation of the determined target operation.

The situation information may include at least one of: a user's action, a user's action pattern, a driving state of the vehicle, a surrounding situation of the vehicle, a current time and location of the vehicle, a status or operation of a device installed in the vehicle, information received from an external source through a communication network, and information obtained from the user or the processor.

The processor may be configured to initiate the determining of the context data based on the situation information when a predefined event occurs. The predefined event may include at least one of: a user's action, a change of status of the vehicle, a change in driving situation, an arrival of a particular time, a change of location, a change of setting information, a change of situation inside the vehicle, and a change of processing of a peripheral device.

The situation-based conversation initiating apparatus may further comprise: a voice receiver configured to receive a user's voice after the speaking content is output, wherein the processor may be configured to analyze the user's voice and generate a control signal for the target operation based on the analyzed voice.

Furthermore, in accordance with embodiments of the present disclosure, a situation-based conversation initiating method includes: collecting situation information using a plurality of sensors disposed within the vehicle; determining context data based on the situation information; determining a target operation based on the context data and a situation analysis model; generating speaking content to be output based on the determined target operation; and visually or audibly outputting the speaking content using an output device.

The situation-based conversation initiating method may further comprise: storing a user's usage history or a history of prior target operations; performing learning based on the user's usage history or the history of prior target operations; and creating the situation analysis model based on a result of the learning. The performing of learning may include performing at least one of rule-based learning and model-based learning.

The collecting of the situation information may include collecting a plurality of pieces of situation information, and the determining of the context data may include extracting at least two correlated pieces of context data among the plurality of pieces of situation information.

The situation-based conversation initiating method may further include determining an operation scenario of an operation entity corresponding to the target operation based on the determined target operation.

The operation entity may include at least one application, and the determining of the operation scenario may include executing the at least one application, and changing a setting of the at least one application based on an operation of the determined target operation.

The situation information may include at least one of: a user's action, a user's action pattern, a driving state of the vehicle, a surrounding situation of the vehicle, a current time and location of the vehicle, a status or operation of a device installed in the vehicle, information received from an external source through a communication network, and information obtained from the user.

The situation-based conversation initiating method may further include initiating the determining of the context data based on the situation information when a predefined event occurs.

The predefined event may include at least one of: a user's action, a change of status of the vehicle, a change in driving situation, an arrival of a particular time, a change of location, a change of setting information, a change of situation inside the vehicle, and a change of processing of a peripheral device.

The situation-based conversation initiating method may further comprise: receiving a user's voice after the speaking content is output; analyzing the user's voice; and generating a control signal for the target operation based on the analyzed voice.

Furthermore, in accordance with embodiments of the present disclosure, a vehicle includes: a situation information collector including a plurality of sensors disposed within the vehicle configured to collect situation information; a processor configured to determine context data based on the situation information, determine a target operation based on the context data and a situation analysis model, and generate speaking content to be output based on the determined target operation; and an output device configured to visually or audibly output the speaking content.

Furthermore, in accordance with embodiments of the present disclosure, a situation-based conversation initiating system includes: a vehicle equipped with a plurality of sensors, a processor, and an output device; and a server device in communication with the processor of the vehicle for receiving situation information collected using the plurality of sensors, determining context data based on the situation information, determining a target operation based on the context data and a situation analysis model, and generating a speaking content to be output based on the determined target operation. The output device of the vehicle is configured to visually or audibly output the speaking content determined by the server device.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, briefly described below.

FIG. 1 is a block diagram of a situation-based conversation initiating apparatus, according to embodiments of the present disclosure.

FIG. 2 shows an example of the exterior of a vehicle.

FIG. 3 shows an example of surroundings of a dashboard of a vehicle.

FIG. 4 is a control block diagram of a vehicle, according to embodiments of the present disclosure.

FIG. 5 is a control block diagram of a processor, according to embodiments of the processor.

FIG. 6 is a block diagram of a situation analyzer according to embodiments of the present disclosure.

FIG. 7 is a diagram for explaining rule-based learning.

FIG. 8 is a diagram for explaining model-based learning.

FIG. 9 is a first diagram for explaining operation of a target operation determiner, according to embodiments of the present disclosure.

FIG. 10 is a second diagram for explaining operation of a target operation determiner, according to embodiments of the present disclosure.

FIG. 11 is a third diagram for explaining operation of a target operation determiner, according to embodiments of the present disclosure.

FIG. 12 is a fourth diagram for explaining operation of a target operation determiner, according to embodiments of the present disclosure.

FIG. 13 is a block diagram of a conversation processor, according to embodiments of the present disclosure.

FIG. 14 shows a situation-based conversation initiating system, according to embodiments of the present disclosure.

FIG. 15 is a flowchart illustrating a situation-based conversation initiating method, according to embodiments of the present disclosure.

FIG. 16 is a flowchart illustrating a method to initiate a conversation based on the user's behavior according to embodiments of the present disclosure.

FIG. 17 is a flowchart illustrating a method to initiate a conversation based on a particular situation occurring to the vehicle while the vehicle is being driven, according to embodiments of the present disclosure.

FIG. 18 is a flowchart illustrating a method to initiate a conversation based on the user's usage pattern, according to embodiments of the present disclosure.

FIG. 19 is a flowchart illustrating a method to initiate a conversation based on the start of operation of a device equipped in a vehicle, according to embodiments of the present disclosure.

FIG. 20 is another flowchart illustrating a method to initiate a conversation based on the start of operation of a device equipped in a vehicle, according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

Furthermore, the control unit of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

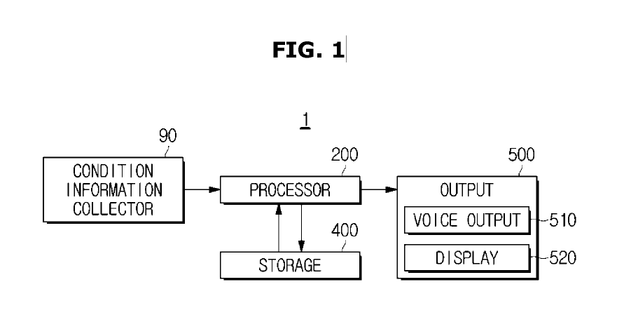

Embodiments of a situation-based conversation initiating apparatus and vehicle having the same will now be described with reference to FIGS. 1 to 13.

FIG. 1 is a block diagram of a situation-based conversation initiating apparatus, according to embodiments of the present disclosure.

As shown in FIG. 1, a situation-based conversation initiating apparatus 1 may include a situation information collector 90, a processor 200, a storage 400, and an output 500.

The situation information collector 90 is configured to collect at least one piece of situation information at least one time.

The situation information may include various kinds of information required for the situation-based conversation initiating apparatus 1 to start a conversation.

For example, the situation information may include at least one of information relating to a user's particular operation, information relating to the user's manipulation or settings of the situation-based conversation initiating apparatus 1 or other related apparatus, information relating to a usage pattern or usage history of the situation-based conversation initiating apparatus 1 or other related apparatus, information relating to operation or state of the situation-based conversation initiating apparatus 1 or other related apparatus, information relating to a current time or location of the situation-based conversation initiating apparatus 1, and other information sent from an external device separate from the situation-based conversation initiating apparatus 1. However, the situation information is not limited thereto. The situation information may include many different kinds of information that may be considered by the designer for the situation-based conversation initiating apparatus 1 to start a conversation.

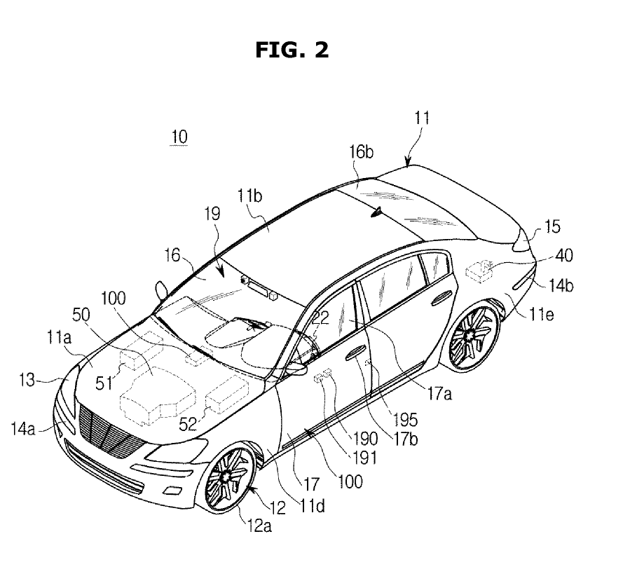

Specifically, for example, if the situation-based conversation initiating apparatus 1 is a vehicle 10 of FIG. 2 or a device equipped in the vehicle 10, e.g., a head unit or a navigation device, the situation information may include at least one of information about a state of the vehicle 10, information relating to a driving situation of the vehicle 10, time information about a current time, spatial information about a current location of the vehicle 10, information about the driver's manipulation of various devices installed inside the vehicle 10, information about settings of various devices input or changed by the driver, information about initiation of operation of a peripheral device, information about a processing result obtained by processing a peripheral device, information received from outside over a communication network, and prior information about information obtained by the user or a processor beforehand.

The situation information collector 90 may collect many different pieces of situation information. In this regard, the situation information collector 90 may use different physical devices, such as sensors, disposed throughout the vehicle to collect the different pieces of situation information. For example, the situation information may include a position and speed of the vehicle, in which case the situation information collector 90 may collect the position of the vehicle using a Global Positioning System (GPS) sensor and collect the speed of the vehicle using a speed sensor, as the situation information.

The situation information collector 90 may collect the situation information periodically or based on predetermined settings. For example, the situation information collector 90 may be configured to collect the situation information only if a particular condition is satisfied. The particular condition may be activation of a certain predefined trigger (i.e., event). The predefined trigger or event may include, for example, the user's action, a change in status of the situation-based conversation initiating apparatus 1, a change in surrounding situation related to operation of the situation-based conversation initiating apparatus 1, arrival of a particular time, a change in location of the situation-based conversation initiating apparatus 1 or a change in setting information or processing result of the situation-based conversation initiating apparatus 1 or related device.

At least a piece of the situation information collected by the situation-based conversation initiating apparatus 1 may be sent to the processor 200 via a wire, a circuit, and/or a wireless communication network. In this case, the situation information collector 90 may send the situation information to the processor 200 in the form of an electric signal.

The processor 200 may be configured to determine an operation corresponding to a situation (hereinafter, called a “target operation”) based on the situation information collected by the situation information collector 90, and to make a conversation with the user based on the target operation. If necessary, the processor 200 may further create a necessary scenario to perform the target operation in addition to the determination of the target operation.

In embodiments of the present disclosure, the processor 200 may extract necessary situation information (hereinafter, called “context data”) among at least one piece of situation information collected by the situation information collector 90, and determine the target operation based on the extracted context data. In other words, receiving a plurality of pieces of situation information from the situation information collector 90, the processor 200 may extract at least one of the plurality of pieces of situation information, and/or extract a part from a piece of situation information. The context data may refer to data with which to analyze a current situation.

In embodiments of the present disclosure, the processor 200 may obtain a situation analysis model by storing various histories, e.g., a history about results of determining a target operation, and performing a learning process using a determined history. The situation analysis model refers to a model that may output a target operation corresponding to a particular situation in response to an input of data about the particular situation.

The processor 200 may determine the target operation using the situation analysis model. If it is difficult to create a situation analysis model because of the lack or absence of the pre-stored history, the processor 200 may determine the target operation based on an extra situation analysis model or various setting values stored by the user or designer in advance.

The processor 200 may use different situation analysis models for an intended target operation. For example, in a fuel shortage situation, the processor 200 may determine a target operation using a situation analysis model about selecting a gas station.

Furthermore, if a predefined event (or trigger) occurs, the processor 200 may determine a target operation corresponding to the situation information. The predefined event may be used as a trigger for operation of the processor 200. Specifically, for example, the processor 200 may initiate obtaining the context data from the situation information in response to the occurrence of an event, and determine a target operation using the obtained context data and the situation analysis model.

The predefined event may include at least one of e.g., a user-defined operation, a change of a status of the situation-based conversation initiating apparatus 1, a change in surrounding situation of the situation-based conversation initiating apparatus 1, an arrival of a particular time, a change of position of the situation-based conversation initiating apparatus 1, a change in various settings that may be related to or obtained by the situation-based conversation initiating apparatus 1, an output of a new processing result of a peripheral device connected to the situation-based conversation initiating apparatus 1, etc. In some cases, the predefined event may be set to correspond to the context data.

Once the target operation is determined, the processor 200 may create a word, a phrase, or a sentence (hereinafter, called a “conversation starter”) in the form of text or a voice signal to be output by the situation-based conversation initiating apparatus 1 to start a conversation, and send the conversation starter to the output 500. The processor 200 may also create the conversation starter based on a created scenario. Accordingly, the processor 200 may actively start a conversation with the user.

The processor 200 may run an application (also referred to as a program or app) stored in the storage 400 to perform a certain computation, processing or control operation, or perform a certain computation, processing, or control operation according to a preset application. The application stored in the storage 400 may be obtained through an electronic software distribution network.

The processor 200 may include a Central Processing Unit (CPU), an Electronic Control Unit (ECU), an Application Processor (AP), a Micro Controller Unit (MCU), a Microprocessor Unit (MPU), and/or any other electronic device capable of various calculations and generation of control signals. The devices may be implemented with at least one semiconductor chip and related parts. The processor 200 may be implemented with a single device or a plurality of devices.

Operation and processing of the processor 200 will be described in more detail later.

The storage 400 is configured to store an application or at least a piece of information related to operation of the situation-based conversation initiating apparatus 1. Specifically, the storage 400 is configured to store an application related to computation, processing, and control operations of the processor 200, information required for the computation, processing and control operations, e.g., history information, or information obtained from a processing result of the processor 200.

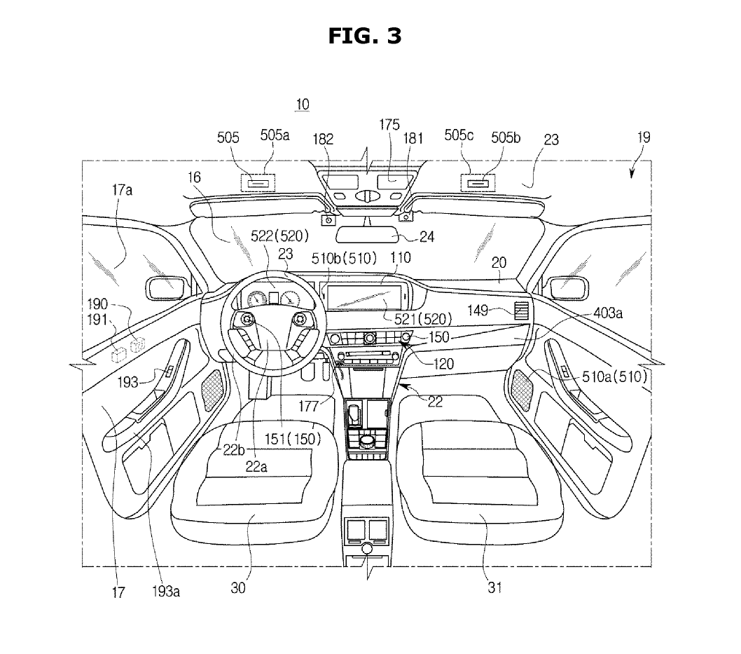

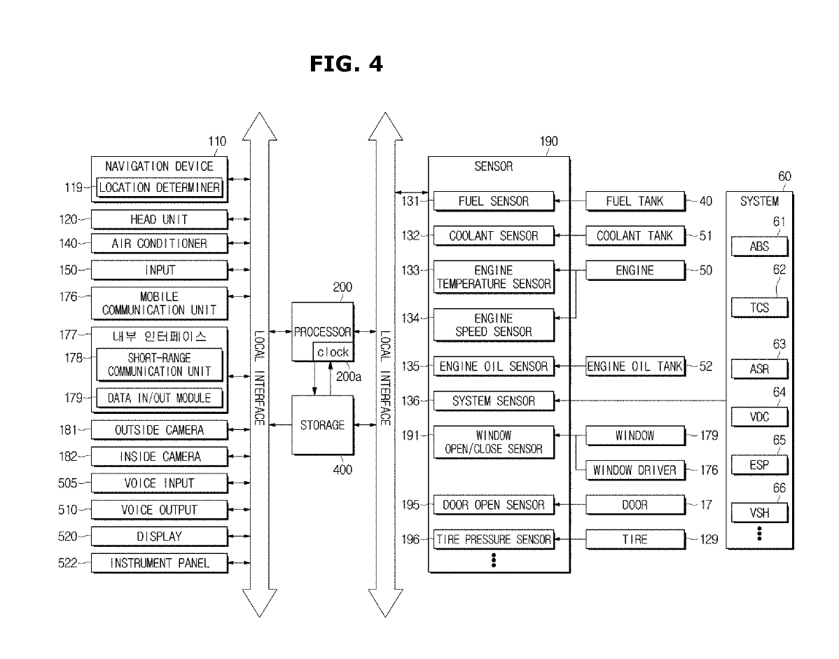

The history information may include information about a usage history of the situation-based conversation initiating apparatus 1 or related device. For example, as for a navigation device 110 of FIGS. 3 and 4 related to the situation-based conversation initiating apparatus 1, the information about a usage history of the system may include information about a series of destinations that have once been input to the navigation device 110 and corresponding route information. The history information may include information about a history corresponding to a result of determination of the processor 200 about the target operation.

In another example, the storage 400 may temporarily or non-temporarily store the situation information obtained by the situation information collector 90 or data generated in the process of computation or processing of the processor 200, e.g., the context data, until the processor 200 calls the information or the data.

The storage 400 may be implemented with a magnetic disc-type storage medium such as a hard disc or a floppy disc, an optical medium such as a compact disc (CD) or a digital versatile disc (DVD), a magneto-optical medium such as a floptical disk, or a semiconductor storage device such as a read only memory (ROM), a random access memory (RAM), a secure digital (SD) card, a flash memory, a solid state drive (SSD), etc.

The output 500 may output and provide the conversation starter for the user. Accordingly, a conversation may be initiated between the user and the situation-based conversation initiating apparatus 1.

The output 500 may include at least one of e.g., a voice output 510 and a display 520.

The voice output 510 outputs the conversation starter by voice. Specifically, if an electronic signal corresponding to the conversation starter is received from the processor 200, the voice output 510 may output the electronic signal by converting it to waves. The voice output 510 may be implemented using e.g., a speaker, an earphone, or any of many different headsets.

The display 520 may visually output the conversation starter. Specifically, the display 520 may output the conversation starter in text, symbols, figures, other various shapes or any combination thereof according to the control signal from the processor 200. The display 520 may be implemented with a display panel, such as a Cathode Ray Tube (CRT), a Liquid Crystal Display (LCD) panel, a Light Emitting Diode (LED) panel, or an Organic Light Emitting Diode (OLED) panel.

In addition, the output may be implemented with various devices capable of providing the conversation starter for the user.

If necessary, the situation-based conversation initiating apparatus 1 may further include an input capable of receiving a response from the user. The input may include a voice receiver for receiving voice produced by the user and outputting the voice in an electric signal (hereinafter, called a “voice signal”). The voice receiver may be implemented with a microphone. The input may include various devices capable of outputting an electric signal corresponding to the user's manipulation, such as a mechanical button, a joy stick, a mouse, a touch pad, a touch screen, a track pad, or a track ball. The signal output from the input may be sent to the processor 200, which may, in turn, create a conversation language or a control signal based on the received signal.

The situation-based conversation initiating apparatus 1 may include various devices capable of mathematical operation and outputting a conversation starter. For example, the situation-based conversation initiating apparatus 1 may include a desktop computer, a laptop computer, a cellular phone, a smart phone, a tablet PC, a vehicle, a robot, various machines or home appliances.

The situation-based conversation initiating apparatus 1 will now be described in more detain by taking a vehicle as an example.

FIG. 2 shows an example of the exterior of a vehicle, and FIG. 3 shows an example of surroundings of a dashboard of a vehicle. FIG. 4 is a control block diagram of a vehicle, according to embodiments of the present disclosure.

As shown in FIG. 2, a vehicle 10 may include a car body 11 forming the exterior of the vehicle 10, at least one car wheels 12 attached to the car body 11 for moving the vehicle 10 while being rotated in a certain direction, a fuel tank 40 for storing the fuel required for operation of the vehicle 10, and an engine 50 installed in an engine room 11a for generating driving force for the car wheels by using the fuel. At least a door 17 is attached to the car body 11 to be opened and closed for the driver or a fellow passenger to get in and out of the vehicle 10.t least one outside lights 13, 14a, 14b may be installed in the vehicle 10, such as headlights 13, direction indicator lights 14a, 14b, etc.

In embodiments of the present disclosure, a window 17a may be installed in the door 17 to be opened and closed. To open and close the window 17a, the door 17 has a window driver 17b including e.g., a motor and various devices which make the window 17a move up and down according to operation of the motor.

As needed, the vehicle 10 may further include a motor for obtaining driving force for the car wheels 12 using electric energy instead of the engine 50 and a battery for supplying electric energy to the motor, in addition to the engine 50.

As shown in FIGS. 2 and 3, an interior room 19 is formed inside the vehicle 10 to accommodate the driver or passenger(s). The engine room 11a and the interior room 19 may be partitioned by a dashboard 20 placed under a windshield 16.

Many different peripheral devices required for the driver or passenger may be installed in the interior room 19 of the vehicle 10. For example, there may be at least one of multimedia systems, such a navigation device 110, a head unit 120 or a radio receiver, a data in/out module 117, an outside camera 181, an inside camera 182, a voice output 510, a voice input 505, an air conditioner 140, a vent 149 connected to the air conditioner 140, a display 520, and an input 150 installed in the interior room 19.

These systems or devices may be installed at any places inside the vehicle 10 according to the designer's or user's selection.

The navigation device 110 is configured to provide maps, regional information, allow route settings, or perform route guidance. The navigation device 110 may be installed e.g., on the top of the dashboard 20 or in the center fascia 22.

Referring next to FIG. 4, the navigation device 110 may include a location determiner 119 for determining a location of the vehicle. The location determiner 119 may measure a location of the vehicle 10. For example, the location determiner 119 may obtain location data using e.g., a Global Navigation Satellite System (GNSS). The GNSS includes a navigation system that uses a radio signal received from an artificial satellite to calculate a location of the receiving terminal. For example, the GNSS may include a navigation system, such as a Global Positioning System (GPS), Galileo, a Global Orbiting Navigational Satellite System (GLONASS), COMPASS, an Indian Regional Navigational Satellite System (IRNSS), a Quasi-Zenith Satellite System (QZSS), etc.

In some embodiments, the location determiner 119 may be embedded inside the vehicle 10 separately from the navigation device 110, e.g., in the inside room of the dashboard 22.

The head unit 120 refers to a device capable of receiving radio signals, tuning a radio frequency, playing music, or performing other various related control operations. The head unit 120 or the radio receiver may be installed in the center fascia 22 placed in the center of the dashboard 20.

The data in/out module 117 is provided for the vehicle 10 to perform wired communication with an external terminal device, e.g., a smart phone or a tablet PC. The vehicle 10 is connected to an external device to communicate with via the data in/out module 117 and at least one cable combined with a terminal of the data in/out module 117. The data in/out module 117 may include e.g., a universal serial bus (USB) terminal, and in addition, at least one of various terminals for interfacing, such as High Definition Multimedia Interface (HDMI) terminals or thunderbolt terminals. The data in/out module 117 may be installed in at least one position, such as in the center fascia 22, a gear box, a console box, etc., according to the designer's selection.

Furthermore, at least one of an outside camera 181 for capturing an image of the outside, e.g., the front, of the vehicle 10 and an inside camera 182 for capturing an image of the interior room 19 of the vehicle 10 may further be installed in the interior room 19. At least one of the outside camera 181 and the inside camera 182 may be installed on the dashboard 20 or on the bottom of a top frame 11b of the car body 11. In this case, the at least one of the outside camera 181 and the inside camera 182 may be installed around a rearview mirror 24.

The at least one of the outside camera 181 and the inside camera 182 may be implemented with a camera device including a Charge Coupled Device (CCD) or a Complementary Metal-Oxide Semiconductor (CMOS). The outside camera 181 and the inside camera 182 may output an image signal corresponding to a captured image.

Furthermore, the voice output 510 for outputting the voice may be installed in the interior room 19 of the vehicle 10. The voice output 510 may be implemented with a speaker device 510a, and the speaker device 501a may be installed at any place, such as on the door 17, on the dashboard 20, and/or on a rear shelf, which may be considered by the designer. The voice output 510 may include a speaker device 510b equipped in the navigation device 110.

Moreover, the voice inputs 505, 505a, 505c may be equipped in the vehicle 10 to receive a voice produced by at least one of the driver or the passenger. The voice input 505 may be implemented with a microphone. The voice input 505 may be installed at a proper position to receive a voice from at least one of the driver and the passenger, which may be, for example, in at least a region 505a, 505c on the bottom of the top frame 11b of the car body 11.

The air conditioner 140 may be installed in the engine room 11a or in the space between the engine room 11a and the dashboard 20 to cool or heat air, and the vent 149 for discharging the air cooled or heated by the air conditioner 140 may be installed in the interior room 19. For example, the vent 149 is installed on the dashboard 20 or the console box.

The display 520 may be installed in the interior room 19 to visually provide various kinds of information for the driver or the passenger. The various kinds of information may include information relating to the vehicle. For example, the information may include information about at least one of speed, engine rpm, engine temperature, an amount of remaining coolant, whether or not the engine oil is short, and/or whether various systems 60 of FIG. 4 installed in the vehicle 10 is operating normally, that the designer intends to provide.

The display 520 may be implemented using e.g., a display 521 installed in the navigation device 110 or an instrument panel 520 installed on the dashboard 20 in front of a steering wheel 23 for providing various indications about the vehicle 10.

The input 150 may receive a command from the driver or the passenger in response to the driver or passenger's manipulation, and send a corresponding signal to the processor 200. The input 510 may be installed on e.g., the center fascia 22, the steering wheel 23, the gear box, an overhead console, a door trim formed on the door, and/or the console box. The input 510 may also be implemented with a touch screen of the navigation device 110.

Furthermore, various lighting devices 175 may be further installed in the interior room 19.

In embodiments of the present disclosure, as shown in FIG. 4, the vehicle 10 may be further equipped with a wireless communication module, e.g., at least one of a mobile communication module 176 and a short-range communication module 178.

The mobile communication module 176 is configured to exchange data with a remote device, e.g., at least one of a server device or a terminal device. The vehicle 10 may access the World Wide Web (WWW) with the mobile communication module 176, and accordingly collect various types of outside information, e.g., news, information about the surroundings of the vehicle 10, weather information, etc.

The mobile communication module 176 may be implemented using a predetermined mobile communication technology. For example, the mobile communication module 176 may be implemented by using at least one communication technology based on a mobile communication standard such as 3GPP, 3GPP2, or WiMax series, and considered by the designer. The mobile communication standard may include, for example, Global System for Mobile Communication (GSM), Enhanced Data GSM Environment (EDGE), Wideband Code Division Multiple Access (WCDMA), Code Division Multiple Access (CDMA), Time Division Multiple Access (TDMA), etc.

The short-range communication module 178 may be configured to wirelessly communicate with a device located within a short range, e.g., a smart phone, a tablet PC, or a laptop computer. The vehicle 10 may be paired with a device within a short range using the short-range communication module 178.

In embodiments of the present disclosure, the short-range communication module 178 may perform communication using a certain short-range communication technology. For example, the short-range communication module 178 may communicate with an external device using Bluetooth, Bluetooth Low Energy, Controller Area Network (CAN), Wi-Fi, Wi-Fi Direct, Wi-MAX, ultra wideband (UWB), Zigbee, infrared Data Association (IrDA) or Near Field Communication (NFC).

The mobile communication module 176 and the short-range communication module 178 may be embedded in e.g., the navigation device 110 or the head unit 120, or mounted on a substrate placed in the space between the engine room 11a and the dashboard 20. In some embodiments, at least one of the mobile communication module 176 and the short-range communication module 178 may be manufactured as separate devices, in which case, at least one of the mobile communication module 176 and the short-range communication module 178 may be connected to the terminal of the data in/out module 179 for performing communication between the vehicle 10 and an external device.

Referring again to FIG. 4, the vehicle 10 may include at least one sensor 190.

The sensor 190 may include at least one of e.g., a fuel sensor 131, a coolant sensor 132, an engine temperature sensor 133, an engine speed sensor 134, an engine oil sensor 135, a system sensor 136, a window open/close sensor 191, a door open sensor 195, and a tire pressure sensor 196.

The fuel sensor 131 is configured to measure an amount of remaining fuel in the fuel tank 40 and output information about the amount of remaining fuel, and the coolant sensor 132 may be configured to measure a remaining coolant in the coolant tank 51 and output information about the remaining coolant. The engine temperature sensor 133 may measure a temperature of the engine 50 and output information about the measured temperature, and the engine speed sensor 134 may measure an engine rpm and output corresponding information. The engine oil sensor 135 is configured to measure a remaining engine oil in the engine oil tank 52 and output information about the remaining engine oil.

The system sensor 136 is configured to detect whether various systems 60 required for operation of the vehicle 10 are operating normally. The system 60 may include at least one of an Anti-lock brake system (ABS) 61 for controlling a hydraulic brake, a Traction Control System (TCS) 62, an Anti-Spin Regular (ASR) 63, Vehicle Dynamic Control (VDS) 64, an Electronic Stability Program (ESP) 65, and a Vehicle Stability Management (VSM) 66. In addition, the system sensor 136 may detect whether the various systems for controlling operation of the respective parts of the vehicle 10 are operating normally in relation to driving of the vehicle 10. The system sensor 136 may be provided for each of the aforementioned systems 60 to 66.

The window open/close sensor 191 may detect whether the window 17a is opened. The window open/close sensor 191 may be implemented with an encoder connected to the window driver 17b, e.g., the motor, or any type of optical sensor or pressure sensor.

The door open/close sensor 195 may detect whether the door 17 is opened. The door open/close sensor 195 may be implemented with a pressure sensor or a switch that is connected when the door 17 is closed.

The tire pressure sensor 196 is configured to measure the pressure of a tire 12a enclosing the outer part of the car wheel 12, and may be implemented with e.g., a piezo-electric sensor or a capacity sensor.

Besides, the vehicle 10 may further include other various sensors for different purposes. For example, the vehicle 10 may further include a sensor for measuring contamination or damage of a certain filter.

Information output from the aforementioned navigation device 110, head unit 120, air conditioner 140, input 150, mobile communication unit 176, internal interface 177, e.g., short-range communication module 178 or data in/out module 179, outside camera 181, inside camera 182, at least one sensor 190, voice input 505, voice output 510, or instrument panel 522 may be used as the situation information as needed. In other words, the devices may each be an example of the situation information collector 90.

The vehicle 10 may further include the processor 200 and the storage 400, as shown in FIG. 4. The processor 200 and the storage 400 are electrically connected to each other for exchanging data.

At least one of the navigation device 110, head unit 120, air conditioner 140, input 150, mobile communication unit 176, internal interface 177, e.g., short-range communication module 178 or data in/out module 179, outside camera 181, inside camera 182, sensor 190, voice input 505, voice output 510, or instrument panel 522 is configured to send data to at least one of the processor 200 and the storage 400 via a conductor line or cable embedded in the vehicle 10 or over a wireless communication network, and/or receive data or control signals from at least one of the processor 200 and the storage 400. The wireless communication network may include the CAN communication.

Operation of the processor 200 will now be described below in more detail.

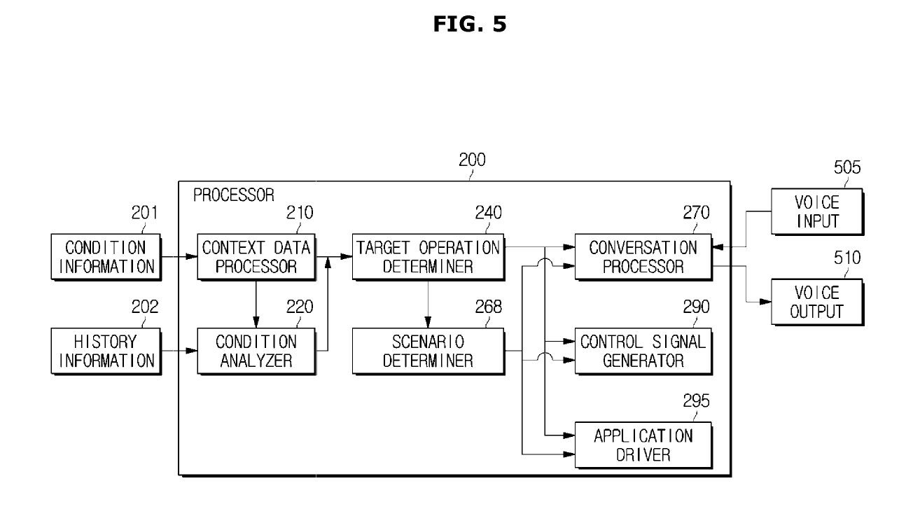

FIG. 5 is a control block diagram of a processor, according to embodiments of the present disclosure.

The processor 200 may obtain context data from situation information each sent from the situation information collector 90 to analyze the situation information, and determine a target operation based on the context data and a situation analysis model provided from the storage 400.

As shown in FIG. 5, the processor 200 may include a context data processor 210, a situation analyzer 220, and a target operation determiner 240, and may further include a scenario determiner 268 as needed. The processor 200 may further include at least one of a conversation processor 270, a control signal generator 290, and an application driver 295 to control operation of other devices, e.g., the navigation device 110, the voice output 510, the air conditioner 140, and the window driver 17b, or other various devices that may be controlled by the processor 200.

The processor 200 may receive situation information 201 from the situation information collector 90, e.g., a device such as the aforementioned navigation device 110. The situation information 201 is forwarded to the context data processor 210.

The context data processor 210 may receive at least a piece of situation information 201, and obtain context data based on the received at least a piece of situation information 201. For example, if receiving information about an input of a command to set a route, information about route setting, and information about an estimated driving distance from the navigation device 110, receive information about an amount of remaining fuel from the fuel sensor 131, and receive corresponding information from other situation information collector 90, e.g., other sensors 131, the context data processor 210 may extract necessary information related to the route setting, e.g., the amount of remaining fuel, as the context data. In this case, other information may be discarded. Furthermore, if a plurality of pieces of information, e.g., information about route setting and estimated driving distance, are received from any situation information collector 90, the context data processor 210 may extract a necessary part of information among them, e.g., only the information about the estimated driving distance, as the context data.

The context data processor 210 may extract necessary context data among situation information collected by the situation information collector 90 according to a setting predefined by the user or designer.

In embodiments of the present disclosure, the context data processor 210 may extract proper context data among the situation information 201 to correspond to a predetermined event that has occurred. Specifically, if the user performs a predetermined operation, there is a predetermined change in status or surrounding situation of the vehicle 10, time and location are within predetermined ranges, and/or a setting value or an output value related to the vehicle 10 or many different devices installed in the vehicle 10, e.g., the navigation device 110, has a change, the context data processor 210 may extract at least one particular context data corresponding to the event from the situation information 201.

The context data processor 210 may also extract a plurality of context data from the same or different situation information. For example, if receiving situation information including an input of a command to set a route, route settings, an estimated driving distance from the navigation device 110 and receiving situation information including an amount of remaining fuel from the fuel sensor 131, the context data processor 210 may extract context data from the situation information 201, both the estimated driving distance and the amount of remaining fuel.

The context data processor 210 may also determine whether to send the context data to the target operation determiner 240. For example, if a command to set a route is input to the navigation device 110 and in response, the navigation device 110 determines a route, the context data processor 210 may compare the estimated driving distance and the amount of remaining fuel to determine whether the amount of remaining fuel is short or whether the amount of remaining fuel is sufficient for driving. If the amount of remaining fuel is not short, the context data processor 210 may not send the context data to the target operation determiner 240 and accordingly, the processor 200 may stop operation. On the contrary, if the amount of remaining fuel is short, the context data processor 210 may send the context data to the target operation determiner 240 and/or the situation analyzer 220, and accordingly, a process of determining a target operation may be performed. In some embodiments, the context data processor 210 may send the context data to the target operation determiner 240, in which case, as will be described later, the target operation determiner 240 may perform the aforementioned operation, e.g., comparison between the estimated driving distance and the amount of remaining fuel.

The context data processor 210 may send the obtained context data to the target operation determiner 240. If there is a plurality of context data obtained, the context data processor 210 may combine the plurality of context data and then send the combined result to the target operation determiner 240. In this case, the context data processor 210 may combine and output a plurality of correlated context data. Being correlated herein means being used together to determine a particular target operation.

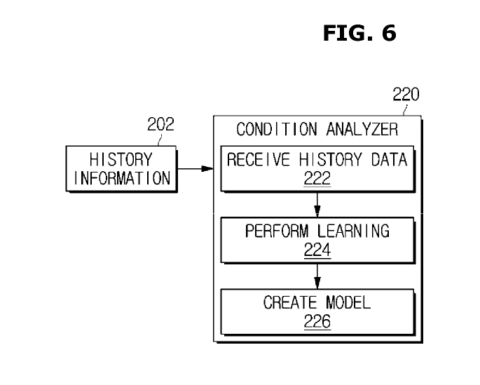

FIG. 6 is a block diagram of a situation analyzer according to embodiments of the present disclosure.

The situation analyzer 220 may create a situation analysis model based on history information 202, and/or send the created situation analysis model to the target operation determiner 240. In this case, the situation analyzer 220 may receive context data extracted from the context data processor 210, sort out a situation analysis model corresponding to the received context data, and send the situation analysis model to the target operation determiner 240, as needed.

Specifically, as shown in FIG. 6, the situation analyzer 220 may receive the history information 202 stored and accumulated in the storage 400 via a circuit, a conductive line or a wireless communication network, in 222, perform learning based on the received history information 202, and create a situation analysis model based on the learning result, in 226.

In some cases, the situation analyzer may use various learning methods based on the received history information 202 to perform learning. For example, the situation analyzer 220 may perform learning using at least one of rule-based learning and model-based learning algorithms.

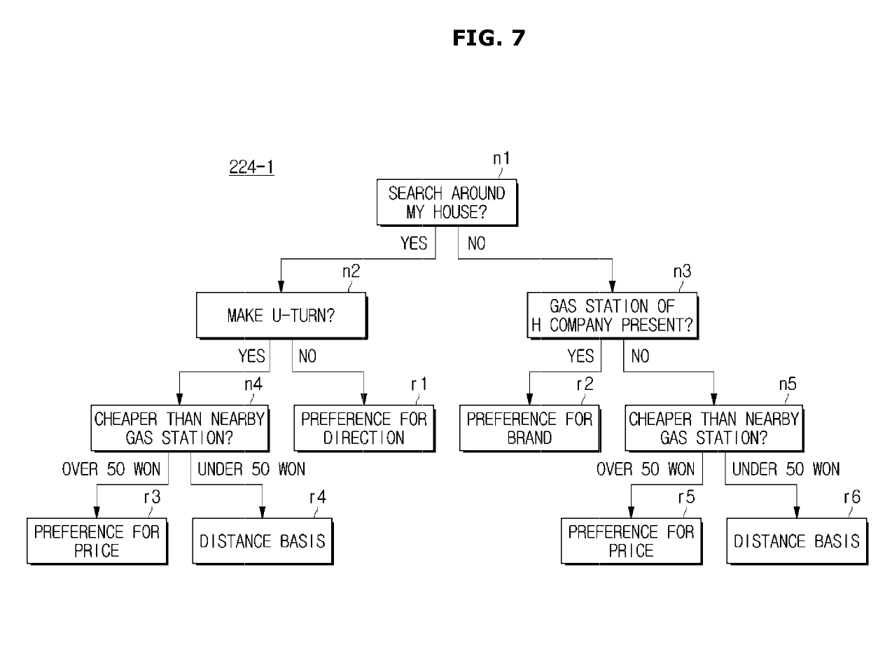

FIG. 7 is a diagram for explaining rule-based learning.

The rule-based learning may include, for example, decision tree learning. The decision tree learning refers to learning performed based on a decision tree formed by putting rules and results into a diagram of a tree structure. The decision tree may include at least one node, which may include a parent node and a plurality of children nodes connected to the parent node. Once a particular value is input to the parent node, one of the plurality of children nodes, which correspond to the particular value, may be selected. This procedure may be sequentially performed, and a final result is obtained accordingly.

The situation analyzer 220 may obtain and update the decision tree based on the input history information 202, and output the obtained and updated decision tree as the situation analysis model to be sent to the target operation determiner 240.

For example, a decision tree 224-1 may be obtained as shown in FIG. 7, if the situation analyzer 220 performs the decision tree learning on searches for gas station. In this case, the decision tree 224-1 may include a plurality of nodes n1 to n5, r1 to r6, and at least two of the plurality of nodes n1 to n5, r1 to r6 are interconnected. Each of the nodes n1 to n5, r1 to r6 has a value (i.e., a condition or a result) corresponding to the user's or designer's selection or a previous learning result. For example, the first node n1 may include a decision of whether a destination is searched for around a particular region (e.g., around my house), and the second node n2 and third node n3, which are children nodes of the first node n1, may include decisions of whether to perform an inconvenient operation (e.g., making a U-turn) and whether there is a particular gas station, respectively. The fourth node n4, a child node of the second node n2 may include a decision of whether a price is relatively inexpensive (n5) and the fifth node n5 may include a result value of a direction preference.

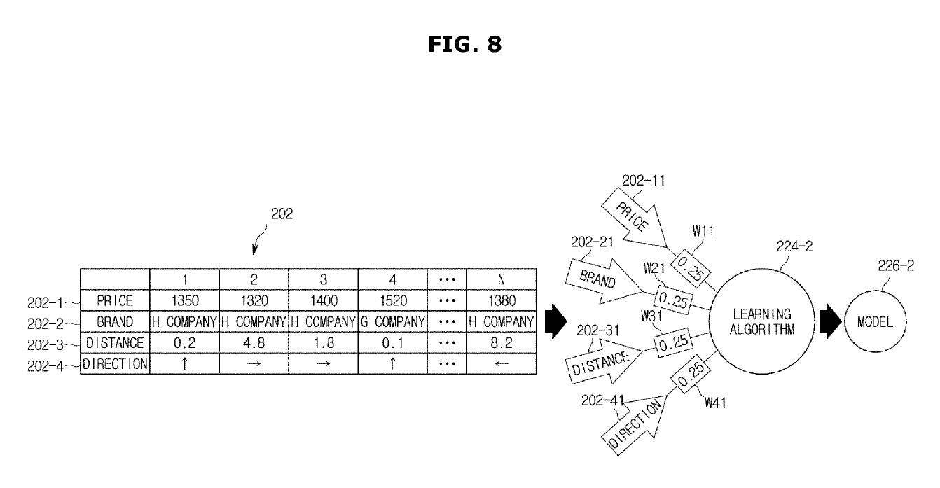

FIG. 8 is a diagram for explaining model-based learning.

The model-based learning may be performed by substituting obtained information in a learning algorithm. The learning algorithm may be implemented using at least one of e.g., a Deep Neural Network (DNN), a Convolutional Neural Network (CNN), a Recurrent Neural Network (RNN), a Deep Belief Network (DBN), and deep Q-network.

Once the history information 202 is obtained, the situation analyzer 200 may perform learning by substituting at least one field value 202-11, 202-21, 202-31, 202-4 of the respective records 202-1 to 202-4 included in the history information 202, e.g., previously selected name of a gas station or store name in a learning algorithm 224-2, and create and update a certain situation analysis model 226-2 based on the learning performance result. In this case, at least one field value 202-11, 202-21, 202-31, and 202-4 may be substituted in the learning algorithm 224-2 after being each assigned a predetermined weight, and all the predetermined weights may be defined to be the same.

The situation analysis model 226-2 obtained from the learning result may be set to meet the user's usage pattern. The situation analysis model 226-2 may include user-based weights equally or differently determined depending on the user's usage pattern. The user-based weight may be a value weighted to each factor obtained from a search result, e.g., price, brand, street, or direction. For example, if learning is performed as shown in FIG. 8, weights applied to price, brand, street, and direction are 0.65, 0.30, 0.04, and 0.01, respectively.

The situation analysis model 226-2 obtained as a learning result is sent to the target operation determiner 240.

The target operation determiner 240 determines a target operation. The target operation refers to at least one operation to be performed according to the situation information.

The target operation determiner 240 may determine the target operation and at least one operation entity to perform the target operation. The at least one operation entity may include the vehicle 10 or a certain device installed in the vehicle 10. For example, the operation entity may be a physical device or a logical device. The physical device may be e.g., the navigation device 110, the head unit 120, or the air conditioner 140. The logical device may be e.g., an application. In addition, the operation entity may be any device capable of performing the target operation. There may be a single operation entity, or two or more operation entities.

Upon reception of the context data from the context data processor 210 and the situation analysis model from the situation analyzer 220, the target operation determiner 240 determines a target operation based on the context data and the situation analysis model.

For example, if the situation analysis model is obtained according to the rule-based learning procedure as shown in FIG. 7, the target operation determiner 240 obtains results corresponding to the context data r1 to r6 by sequentially making decisions corresponding to the respective nodes n1 to n5 based on the context data. For example, as described above, if a gas station is to be searched for, the target operation determiner 240 obtains results based on the context data, such as preference for a direction r1, preference for a price r3, r5, or a distance basis (r4, r6). Specifically, if situation information indicating that a destination is searched for from around my house and situation information indicating that there is no need to make a U-turn are input, the target operation determiner 240 may obtain the preference for a direction as a result. Once the results are obtained r1 to r6, the target operation determiner 240 determines a target operation based on the obtained results. For example, if the preference for a direction r1 is obtained as a final result from the rule-based learning, the target operation determiner 240 may determine arranging of a plurality of gas stations as a target operation based on the preference for a direction r1. The target operation determiner 240 may determine recommending of the most preferred gas station among the plurality of gas stations as a target operation based on the preference for a direction r1.

Furthermore, if the situation analysis model is obtained from a model-based learning process as shown in FIG. 8, the target operation determiner 240 may input context data to an input layer of the situation analysis model to obtain a result based on the context data and previous learning.

In embodiments of the present disclosure, the operation determiner 240 may compare a plurality of factors with the obtained situation analysis model 226-2, detect a factor with the highest similarity from among the plurality of factors and determine an operation. For this, the operation determiner 240 may use a similarity measure method. For example, to determine a gas station, the operation determiner 240 may obtain a particular gas station by detecting the same or similar gas station to the substitution result of the situation analysis model 226-2 among at least one gas stations searched for, and determine recommending of the particular gas station as a target operation. Specifically, the operation determiner 240 may determine a target operation by applying an obtained user-based weight to a field value stored in a plurality of gas station records, e.g., gas station name, brand, price, distance, or direction and substituting the weighting results in the situation analysis model 226-2 to select one of the plurality of gas station records, and determining a gas station corresponding to the selected record as a recommended gas station.

In addition, the target operation determiner 240 may determine the target operation in other various ways. The process of determining a target operation and the determination results may be designed in various ways according to the user's or designer's selection.

The target operation determiner 240 may be implemented using an intelligent agent.

An example of a process of determining a target operation in the target operation determiner 240 will now be described in more detail.

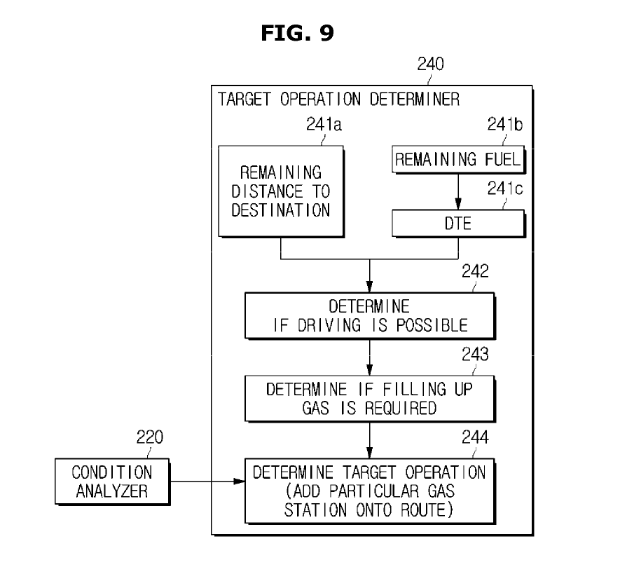

FIG. 9 is a first diagram for explaining operation of a target operation determiner, according to embodiments of the present disclosure. Specifically, FIG. 9 shows an example of determining a target operation in a case that a distance to empty (DTE) based on an amount of remaining fuel is shorter than an estimated remaining distance to a destination if the user sets the destination to the navigation device 110 installed in the vehicle 10.

Referring to FIG. 9, the target operation determiner 240 receives context data about a remaining distance 241a to the destination and context data about an amount of remaining fuel 241b from the context data obtainer 210. The context data about the remaining distance 241a to the destination is extracted from the situation information sent from the navigation device 110, and the amount of remaining fuel 241b is extracted from the situation information sent from the fuel sensor 131. Once the amount of remaining fuel 241b is obtained, the target operation determiner 240 may calculate a DTE 241c corresponding to the amount of remaining fuel 241b.

The target operation determiner 240 may determine whether it is possible to drive to the destination by comparing the remaining distance 241a to the destination and the DTE 241c, in 242. If it is determined that the remaining distance 241a to the destination is shorter than the DTE 241c, the target operation determiner 240 determines that there will be no problem with the fuel and performs no extra operation. On the contrary, if it is determined that the remaining distance 241a to the destination is longer than the DTE 241c, the target operation determiner 240 may determine that the amount of remaining fuel is short and that the vehicle needs to be filled up with gas, in 243. This process may be skipped if the context data processor 210 determines whether to drive or whether to fill up gas, as described above.

If it is determined that filling up the gas is required, the target operation determiner 240 determines a target operation based on the situation analysis model sent from the situation analyzer 220, in 244. The target operation herein may be set to an operation of adding a particular gas station determined based on the situation analysis model as a stopover onto the route to the destination. The operation entity may be set to be the navigation device 110.

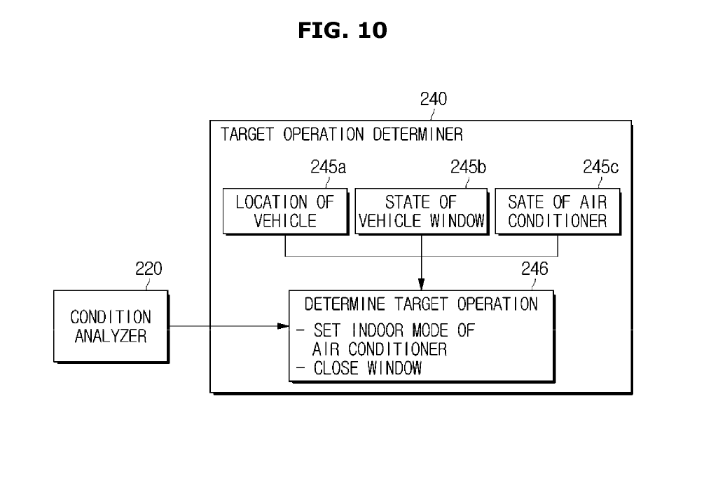

FIG. 10 is a second diagram for explaining operation of a target operation determiner, according to embodiments of the present disclosure. Specifically, FIG. 10 shows an example of determining a target operation corresponding to a case where there is a tunnel present in front of the vehicle 10 being driven with the window 17a of the vehicle 10 opened and the air conditioner 140 operating in outdoor air mode.

Referring to FIG. 10, the target operation determiner 240 may receive context data including a physical location 245a of the vehicle 10 (or information indicating that there is a nearby tunnel on the driving route), a state 245b of the vehicle window 17a, and a state 245c of the air conditioner 140, from the context data obtainer 210. The information may be received from a medium storing information about the location determiner 119 and/or air conditioner 140, e.g., the storage 400 and the window open/close sensor 191.

If the vehicle 10 is expected to enter a tunnel in a short time, the vehicle window 17a is opened, and/or the air conditioner 140 is operating in the outdoor air mode, the target operation determiner 240 determines a target operation based on the situation analysis model sent from the situation analyzer 220, in 246. The target operation herein may include an operation determined based on the situation analysis model to prevent inflow of dust into the vehicle 10, i.e., operation of closing the window 17a and/or operation of putting the air conditioner 140 into an indoor air mode.

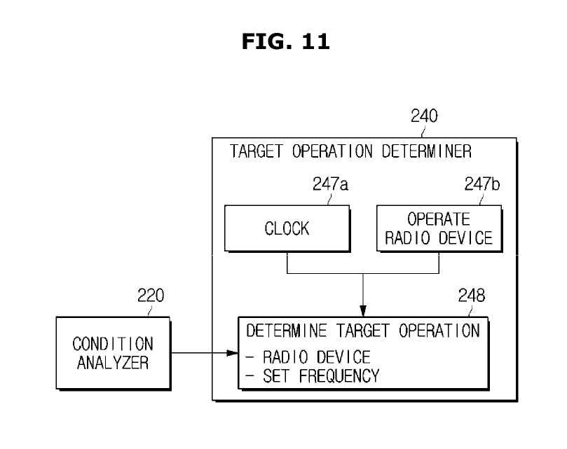

FIG. 11 is a third diagram for explaining operation of a target operation determiner, according to embodiments of the present disclosure. FIG. 11 shows a process of determining a target operation upon arrival of a particular time as an example of determining a target operation based on the user's usage pattern.

Referring to FIG. 11, the target operation determiner 240 may receive context data representing current time and an operation status of the head unit 120 (or radio device) from the context data obtainer 210. The information may be sent from a clock 200a and the head unit 120.

The target operation determiner 240 determines a target operation of the head unit 120 at the particular time by applying the information about the current time and the operation status of the head unit 120 to a situation analysis model sent from the situation analyzer 220, in 246. In this case, the situation analysis model may be implemented with a particular time and a preferred media (preferred broadcasting service) as input and output values. If the user has set the head unit 120 to receive a broadcasting service of a first frequency in about 95% proportions and a broadcasting service of a second frequency in about 5% proportions in a particular time zone, the history is reflected onto the situation analysis model and accordingly, a situation analysis model is obtained for a relationship between particular time and preferred media. Based on the situation analysis model, if the current time corresponds to the particular time zone or a time right before the particular time zone, the target operation determiner 240 may determine playing a preferred broadcasting service, e.g., the broadcasting service of the first frequency (or changing a set frequency to the first frequency) as a target operation.

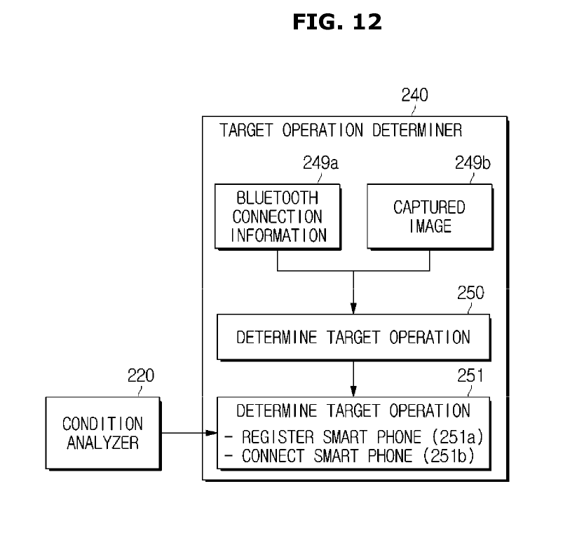

FIG. 12 is a fourth diagram for explaining operation of a target operation determiner, according to embodiments of the present disclosure. Specifically, FIG. 12 shows an example of a process of determining an available target operation if there is a passenger in the vehicle 10 and the passenger has a terminal device.

Referring to FIG. 12, the target operation determiner 240 may receive context data about information regarding Bluetooth connection and about a captured image 249b from the context data obtainer 210. The context data obtainer 210 may obtain the information from the data in/out module 179 and the inside camera 182.

The target operation determiner 240 may determine people seated in the vehicle 10 based on the captured image 249b, and determine who the driver is among the people seated in the vehicle 10 if necessary. Who the driver is may be determined based on positions of the people seated in the vehicle in the captured image 249b.

If a terminal device having no history of being connected before is connected to the vehicle 10 through the Bluetooth, the target operation determiner 240 determines based on the situation analysis model that the terminal device of the driver is connected to the vehicle 10 and determines operation of confirming and determining the newly connected terminal device as the driver's terminal device as the target operation, in 251a.

If there is no terminal device connected through the Bluetooth but a history of previous connections of a terminal device is present, and several terminal devices available for connection are detected, the target operation determiner 240 determines based on the situation analysis model obtained by the situation analyzer 200 that the driver's terminal device would typically be connected to the vehicle 10, and determines who the driver is by performing face recognition on the captured image 249a based on the situation analysis model. Subsequently, the target operation determiner 240 determines operation of connecting the driver's terminal device through the Bluetooth as a target operation, in 25 lb.

Although various examples of operation of the target operation determiner 240 are described above, the target operation determiner 240 may determine various target operations using various other kinds of situation information.

For example, upon arrival of a time corresponding to a registered schedule, the target operation determiner 240 may determine setting a destination to a location corresponding to the schedule as a target operation; upon activation of a particular pictogram of the instrument panel 522, the target operation determiner 240 may determine initiating an explanation of the particular pictogram as a target operation; if current sound volume of the head unit 120 is different from a preferred volume, the target operation determiner 240 may determine changing the volume of the head unit 120 as a target operation. Furthermore, the target operation determiner 240 may determine operation of suggesting car washing and/or setting a route to a car wash as a target operation if the information received through the mobile communication unit 176, e.g., weather information, indicates a proper weather for car washing, and determine operation of outputting warning of low tire pressure and/or directing a route to a car repair shop as a target operation if the pressure measured by the tire pressure sensor 196 is below a predetermined threshold.

Based on the target operation determined by the target operation determiner 240, the scenario determiner 268 may determine and create a necessary scenario for the operation entity to perform the target operation. The scenario refers to a collection of a series of operations to be performed sequentially to do the target operation. For example, once a recommended gas station is determined as described above, the scenario may include various operations, e.g., creating a conversation starter for recommending a gas station, generating a control signal for the voice output 510 or the display 520, determining whether to set a route change, and generating and confirming a signal to control a route change.

The scenario determiner 268 may be omitted as needed.

Once the target operation is determined by the target operation determiner 240 or a scenario for a series of operations to perform the target operation is determined, the target operation and the scenario are changed into the form of text, and at least one of the conversation processor 270, the control signal generator 290, and the application driver 295 performs the operation according to at least one of the target operation and the scenario.

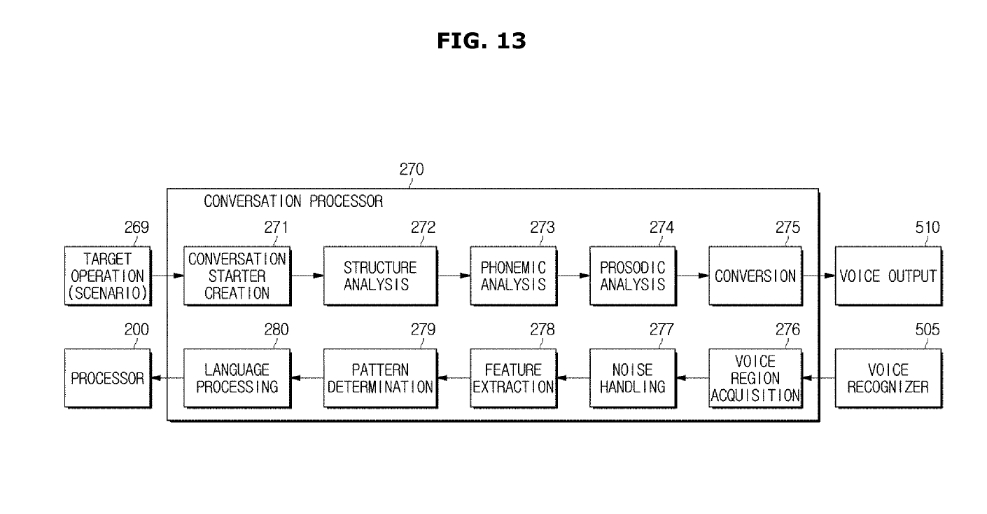

FIG. 13 is a block diagram of a conversation processor, according to embodiments of the present disclosure.

The conversation processor 270 is configured to make a conversation with the user, e.g., the driver or the passenger. The conversation processor 270 creates a conversation starter corresponding to at least one of the target operation and the scenario, generates and sends a signal corresponding to the conversation starter to the output 500, e.g., the voice output 510. The voice output 510 outputs the conversation starter by voice, and accordingly, a conversation is initiated between the user and the vehicle 10.

Referring to FIG. 13, the conversation processor 270 may output a voice signal corresponding to the target operation through a procedure of conversation starter creation 271, structure analysis 272, phonemic analysis 273, prosodic analysis 274 and conversion 275.

The conversation starter creation 271 refers to an operation of creating a word, a phrase, or a sentence corresponding at least one 269 of the target operation and the scenario in the form of text. The conversation starter may be created according to at least one of the target operation and the scenario sent to the conversation processor 270. The conversation starter may be created by reading a database separately provided, to detect a word, phrase, or sentence corresponding to at least one of the target operation and the scenario. Alternatively, a word, phrase, or sentence may be created by combining or modifying several words or affixes based on at least one of the received target operation and scenario. In this case, creation of word, phrase, or sentence is performed according to features of a language (e.g., an agglutinative language, an inflected language, an isolated language, or an incorporating language) intended to be output.

The structure analysis 272 refers to a process of analyzing a structure of the created conversation starter, e.g., the sentence structure, and based on which, obtaining a word, phrase, etc. The structure analysis 272 may be performed using a grammar rule provided in advance. If necessary, a normalization process may further be performed along with the structure analysis. The phonemic analysis 273 refers to a process of converting text to phonemes to obtain a phone sequence by assigning a word or phrase obtained in prosodic units a corresponding pronunciation. The prosodic analysis 274 refers to a process of assigning prosodies such as pitches or rhythms to the phone sequence. The conversion 275 refers to a process of obtaining a voice signal to be actually output by synthesizing the phone sequence and prosodies obtained by the aforementioned processes. The obtained voice signal may be sent to the voice output 510, which may in turn generate and output sound waves corresponding to the voice signal.

Accordingly, the user may listen to the sentence corresponding to the target operation 269 and/or the scenario by voice. For example, if the target operation is determined as an operation of adding a gas station of H company onto a route to a destination (e.g., a workplace) as a stopover, the user may listen to a sentence “Gas is not enough to the destination. Shall we add a gas station of H Company onto the route to the office?” by voice.

The user, e.g., the driver or the passenger may speak a word of an answer to the voice heard. For example, the user may tell an answer of yes or no to the target operation- or scenario-based operation. The voice produced by the user is received by the voice input 505.

The conversation processor 270 may convert the voice signal input to the voice input 505 into the form that may be processed by the processor 200, e.g., the form of a character string.

Referring again to FIG. 13, the conversation processor 270 may convert the voice signal produced by the user into word, phrase, or sentence in the form of text through a procedure of acquisition of a voice region 276, noise handling 277, feature extraction 278, pattern determination 279, and language processing 280.

The acquisition of a voice region 276 refers to finding a region in which a voice produced by the user is present or likely present. The conversation processor 270 may detect the voice region by analyzing the frequency of the received analog voice signal or using various other means separately provided.

The nose handling 277 may cancel unnecessary noise from the voice region other than the voice. The noise handling may be performed based on frequency characteristics of the voice signal or based on directivity of the received voice.

The feature extraction 278 may be performed by extracting a feature of the voice e.g., a feature vector, from the voice region. For this, the conversation processor 270 may employ at least one of Linear Prediction Coefficient (LPC), Cepstrum, Mel Frequency Cepstral Coefficient (MFCC), and Filter Bank Energy.

The pattern determination 279 refers to a process of determining a pattern corresponding to the extracted feature from the voice signal by comparing the extracted feature and a predetermined pattern. The predetermined pattern may be determined using a predetermined acoustic model. The acoustic model may be obtained by modeling signal characteristics of the voice in advance. The acoustic model may be configured to determine a pattern according to at least one of a firsthand comparison method to set a target to be recognized in a feature vector model and compare it with a feature vector of voice data and a statistical method to schematically process and use the feature vector of the target to be recognized. The firsthand comparison method may include vector quantization. The statistical modeling method may include a scheme using Dynamic Time Warping (DTW), the Hidden Markov Model (HMM) or a neural circuit network.

The language processing 280 refers to a process of determining a vocabulary, a grammar structure, and a subject of the sentence based on the determined pattern and obtaining a final recognized sentence based on the determination. The language processing 280 may be performed using a predetermined language model. The language model may be created based on a human language and grammar in order to determine linguistic order relations of the recognized words, phrases or sentences. The language model may include e.g., a statistical language model or a finite state automata (FSA) based model.

In some cases, the pattern determination 279 and the language processing 280 may also be performed using the N-best search algorithm that incorporates an acoustic model and a voice model.

With the aforementioned processes, word(s), phrase(s), or sentence(s) (i.e., character string(s)) corresponding to the voice produced by the user is obtained. The obtained word, phrase, or sentence may be sent to the processor 200, which may, in turn, determine what the answer from the user is, based on the word, phrase or sentence, and generate a control signal or run a predetermined application based on the determination. Furthermore, the processor 200 may generate another response to the user's answer through the conversation processor 270, and output the response in a corresponding voice signal according to the aforementioned method.

The control signal generator 290 may generate a predetermined control signal based on at least one of a target operation determined by the target operation determiner 240, a scenario determined by the scenario determiner 268, and the user's answer output by the conversation processor 270.

The predetermined control signal includes a control signal for an operation entity. For example, once an operation of resetting a route of the navigation device 110 is determined as a target operation, the control signal generator 290 may generate a control signal to reset a route and send the control signal to an operation entity, i.e., the navigation device 110.

In embodiments of the present disclosure, the control signal generator 290 may generate a control signal for the display 520 to provide the user with a conversation starter including a word, phrase, or sentence corresponding to the target operation or scenario. Accordingly, the processor 200 may be able to start a conversation with the user in a visual manner. In response, the user may input a response by manipulating the input 150 such as a keyboard device or a touch screen. Therefore, even if the conversation processor 270 is not present, the user and the vehicle 10 may make a conversation between them.

The application driver 295 may run an application set to be driven, for the vehicle 10 or various devices installed in the vehicle 10 to perform a certain operation. The application may include one that may be driven in the vehicle 10, including e.g., a navigation application, a call application, a sound player application, a still image display application, a moving image player application, an information provider application, a radio application, a vehicle management application, a digital media broadcast player application, or a reverse assistant application, without being limited thereto.

The application driver 295 may run at least one application, revise setting information of at least one application, and/or stop running at least one application based on at least one of a target operation determined by the target operation determiner 240, a scenario determined by the scenario determiner 268, and the user's answer output by the conversation processor 270.

An example of a situation-based conversation initiating system will now be described.

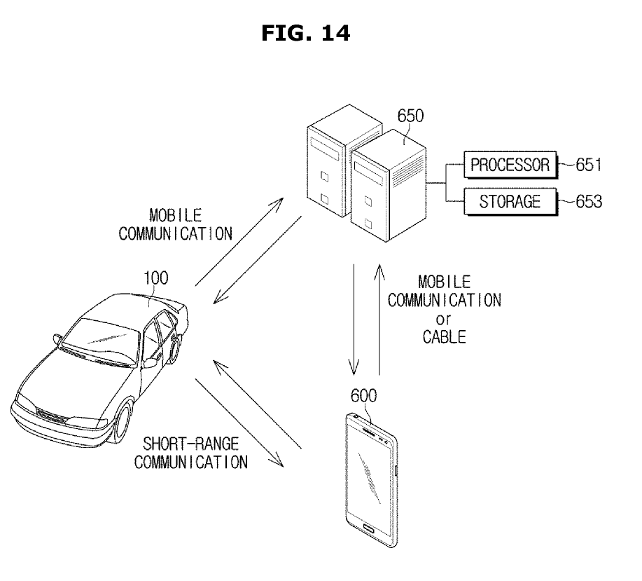

FIG. 14 shows a situation-based conversation initiating system, according to embodiments of the present disclosure.

A situation-based conversation initiating system 60 may be implemented with the vehicle 10, a terminal device 610 connected to the vehicle 10 to communicate with, and a server device 650 connected to the terminal device 610 to communicate with.

The vehicle 10 and the terminal device 610 may perform mutual communication using a short-range communication technology. For example, the vehicle 10 and the terminal device 610 may perform mutual communication using Bluetooth or NFC technology. Situation information obtained by the vehicle 10 may be sent to the terminal device 610 over a short-range communication network formed between the vehicle 10 and the terminal device 610.

The terminal device 610 and the server device 650 may communicate with each other over a wired or wireless communication network. The terminal device 610 may send the situation information obtained by the vehicle 10 to the server device 650, and receive a target operation, a scenario, or various control signals obtained according to a processing result of the server device 650. The received target operation, scenario, or various control signals may be sent to the vehicle 10 as needed. The vehicle 10 may perform an operation such as outputting a voice according to the received target operation or scenario. In some embodiments, the terminal device 610 may perform an operation corresponding to the received target operation, scenario or various control signals. For example, the terminal device 610 may perform the aforementioned operation of the conversation processor 270.

The server device 650 may perform various mathematical operations, processing and control associated with operation of the vehicle 10. The server device 650 may include a processor 651 and a storage 653.

The processor 651 may determine a target operation based on the situation information received from the vehicle 10, as described above. In this case, the processor 651 may obtain context data, obtain a situation analysis model based on various histories stored beforehand, and determine a target operation using the context data and the situation analysis model. Furthermore, the processor 651 may determine a scenario corresponding to the target operation. The target operation or scenario obtained as describe above may be sent to the terminal device 610. The processor 651 may also determine an operation of the vehicle 10 in response to the user's answer to a voice output, and generate and send a control signal of the determined operation to the terminal device 610.

The storage 653 may store various kinds of information required for operation of the processor 651, such as a situation analysis model.

Structure, operation, or illustration of the processor 651 and storage 653 may be the same as or be modified in part from the structure, operation, or illustration of the processor 200 and storage 400 of the vehicle 10, so the detailed description of them will be omitted below.

In some embodiments, the terminal device 610 may be omitted. In this case, the vehicle 10 may perform direct communication with the server device 650 using the mobile communication unit 176 of FIG. 4 equipped in the vehicle 10, send the situation information directly to the server device 650, and receive a target operation, a scenario, or various control signals from the server device 650.

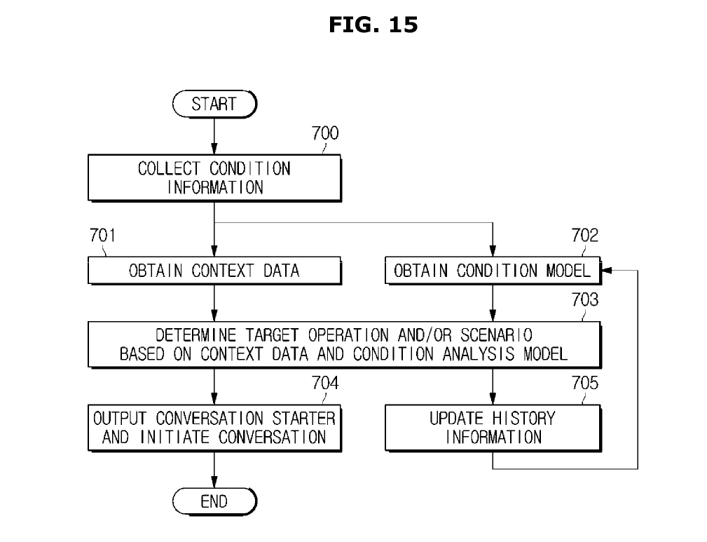

A situation-based conversation initiating method will now be described with reference to FIGS. 15 to 20.

FIG. 15 is a flowchart illustrating a situation-based conversation initiating method, according to embodiments of the present disclosure.

As shown in FIG. 15, the example of the situation-based conversation initiating method begins with collecting situation information by a situation information collector equipped in the situation-based conversation initiating apparatus (e.g., the vehicle), in 700. The situation information may include at least one of the user's action, the user's action pattern, a driving state of the vehicle, a surrounding situation of the vehicle, current time and location of the vehicle, status or operation of the respective devices installed in the vehicle, information received from outside through a communication network, and information obtained beforehand by the user or the processor.

The situation information collector may collect the situation information periodically or according to a predetermined setting.

The situation information collector may initiate collecting the situation information by a predetermined trigger. The trigger may include at least one of e.g., the user's action, a change in status of the situation-based conversation initiating apparatus, e.g., the vehicle, a surrounding situation or a change in surrounding situation, arrival of a particular time, a change of location, a change of setting information, a change of an inside situation, and a change of a processing result of a peripheral device.

Once the situation information is collected, context data may be obtained from the situation information, in 701. It is possible to obtain two or more context data, which may be originated from the same or different pieces of situation information. If a plurality of correlated context data is obtained, they may be combined and then processed.

A situation analysis model and the context data may be obtained simultaneously or at different times, in 702. The situation analysis model may be obtained by a predetermined learning method based on accumulated history information. The predetermined learning method may include at least one of the rule-based learning method and the model-based learning method. The history information may include a usage history of the situation-based conversation initiating apparatus 1 or related device. The history information may also include a history of results of determining the target operation of the situation-based conversation initiating apparatus 1.

Once the context data and the situation analysis model are obtained, a target operation may be determined based on the context data and the situation analysis model, and a scenario corresponding to the target operation may further be determined as required, in 703. Specifically, the target operation may be determined by substituting the context data in the situation analysis model and obtaining a resultant value output from the situation analysis model.

If at least one of the target operation and the scenario is determined, a conversation starter corresponding to the target operation and the scenario is created and visually or audibly provided to the user, in 704. Accordingly, a conversation may be initiated between the situation-based conversation initiating apparatus and the user.

Furthermore, at least one of the result of determining the target operation, a response of the user to the result, and an operation based on the response of the user is added to the history information, and accordingly, the history information may be updated, in 705. The history information may be used later in the process of obtaining the situation analysis model, in 702.

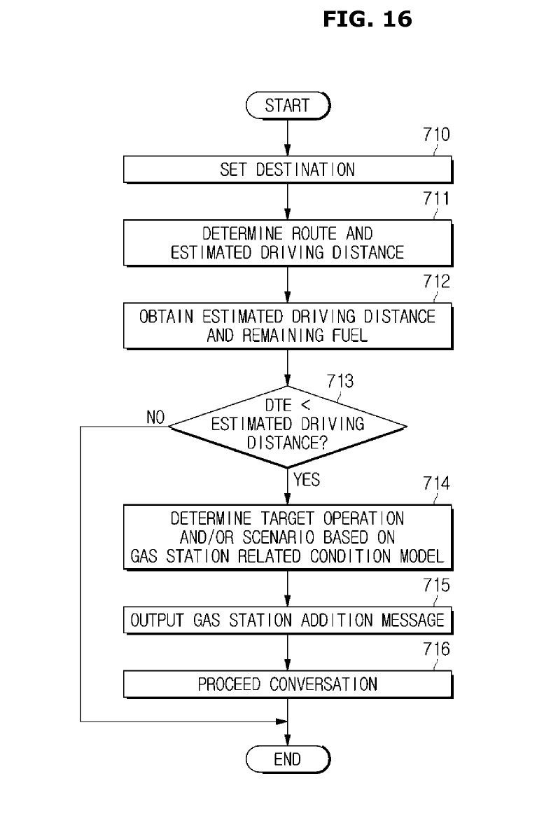

Specific examples of the situation-based conversation initiating method will now be described with reference to FIGS. 16 to 20.

FIG. 16 is a flowchart illustrating a method to initiate a conversation based on the user's behavior according to embodiments of the present disclosure. For example, a conversation is initiated when the user takes an action to set a destination on the navigation device.

As shown in FIG. 16, if the user sets a destination by manipulating the navigation device in 710, the navigation device may determine a route and an estimated driving distance to the destination, in 711.

In response to operation of the navigation device, situation information may be obtained, in 712. The situation information may include e.g., an estimated driving distance and an amount of remaining fuel. The estimated driving distance may be obtained by the navigation device, and the amount of remaining fuel may be obtained by the fuel sensor.

Once the amount of remaining fuel is obtained, a DTE corresponding to the amount of remaining fuel is calculated and compared with the estimated driving distance, in 713. If the DTE is longer than the estimated driving distance, in 713, subsequent processes are skipped and the associated conversation is not initiated.

On the contrary, if the DTE is shorter than the estimated driving distance, in 713, a target operation may be determined based on a situation analysis model separately provided to select a gas station, and a scenario corresponding to the target operation may be determined as needed, in 714. The target operation may be an operation of adding a gas station as a stopover onto a route.

Once the target operation and/or scenario is determined to be an operation of adding a gas station as a stopover, a conversation starter is created to ask if the gas station selected based on the situation analysis model will be added to the route, and provided for the user by being visually or audibly output, in 715.

Accordingly, a conversation related to addition of a gas station to a route due to fuel shortage is initiated and proceeds, in 716. In the meantime, the determination result and an operation corresponding to the user's response to the result may be added to the history information and stored, and also used to create a situation analysis model.

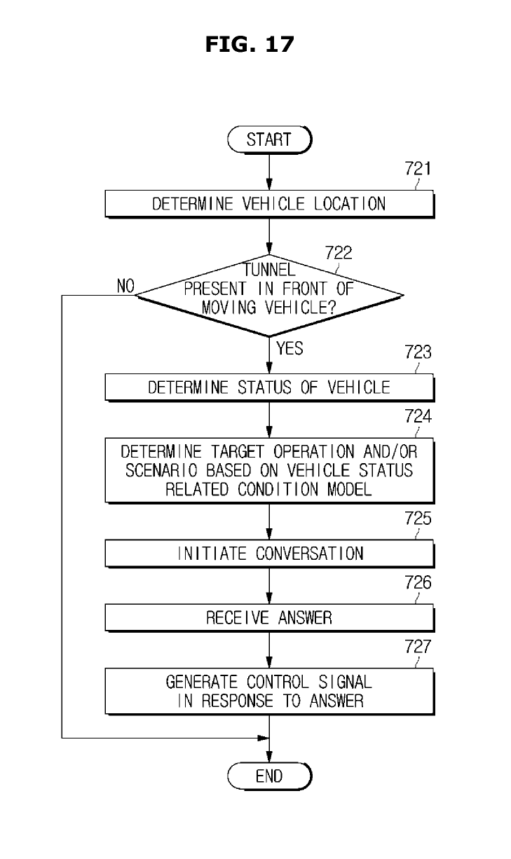

FIG. 17 is a flowchart illustrating a method to initiate a conversation based on a particular situation occurring to the vehicle while the vehicle is being driven, according to embodiments of the present disclosure. An example of initiating a conversation when the vehicle is approaching a tunnel is shown.

As shown in FIG. 17, location of the vehicle is determined by means of e.g., the navigation device, and accordingly, situation information relating to the location of the vehicle is obtained, in 721.

Subsequently, it is determined whether there is s tunnel present in front of the moving vehicle by referring to a map, and accordingly situation information relating to whether there is a tunnel is obtained, in 721.

If there is no tunnel present in front of the vehicle in 721, the following procedure may be skipped, and thus, no conversation about the presence of a tunnel is initiated.

Furthermore, situation information about status of the vehicle may also be collected, in 723. For example, whether a window of the vehicle is opened, an operation mode of the air conditioner or the like may be determined.

Determination of a location of the vehicle 721, determination of whether there is a tunnel in front of the vehicle 722, and collection of situation information about status of the vehicle 723 may be performed simultaneously or sequentially. In the latter case, the determination of a location of the vehicle 721 may be performed first, or the collection of situation information about status of the vehicle 723 may be performed first.

Among the obtained several pieces of situation information, the information about whether there is a tunnel and about status of the vehicle may be extracted as context data, and based on the context data and the situation analysis model, a target operation and/or a scenario may be determined, in 724. The target operation may include at least one of operation of closing the window and operation of indoor air mode.

Once the target operation and/or the scenario is determined, a conversation starter about at least one of the operation of closing the window and the operation of indoor air mode is created, and visually or audibly provided for the user, in 725. Accordingly, a conversation is initiated between the user and the situation-based conversation initiating apparatus.

The user may listen to the conversation starter and in response, may speak a word of an answer, in 726.

The situation-based conversation initiating apparatus may receive the answer and generate a control signal corresponding to the answer. If the user's answer is yes to a suggestion included in the conversation starter, a control signal of at least one of the operation of closing the window and the operation of indoor air mode is generated and accordingly, the window is closed and/or the operation mode of the air conditioner may be changed to the indoor air mode.

The history of determination results or associated responses of the user is stored separately and used in creating a future situation analysis model.

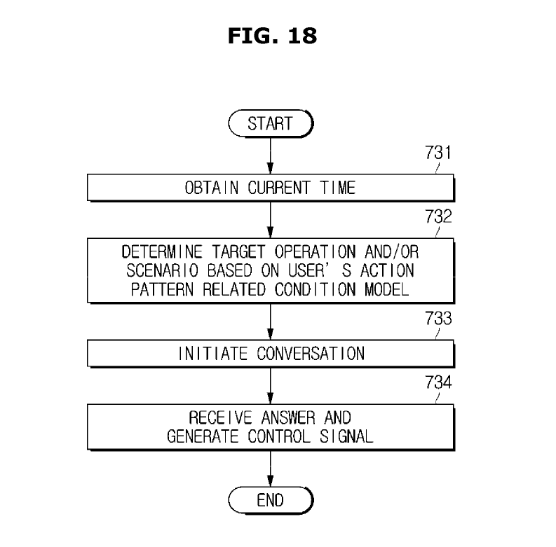

FIG. 18 is a flowchart illustrating a method to initiate a conversation based on the user's usage pattern, according to embodiments of the present disclosure. An example of initiating a conversation based on the user's usage pattern of the head unit is shown in a case of arrival of a particular time.

As shown in FIG. 18, information about a current time is obtained as situation information, in 731.

The information about a current time is extracted as the context data, and a target operation and/or scenario is determined based on the information about the current time and a situation analysis model related to the user's usage pattern at particular times, in 732. For example, the target operation may include an operation of initiating the head unit and/or an operation of changing the current frequency of the head unit to another frequency.

Once the target operation and/or scenario is determined, a corresponding conversation is initiated, in 733. Specifically, a conversation starter about the operation of the head unit is created, and visually or audibly provided for the user, causing initiation of a conversation.

The user may listen to the conversation starter and in response, speaks a word of an answer, and the situation-based conversation initiating apparatus may receive the answer and generate a control signal corresponding to the answer, in 734. For example, the head unit is operated to receive a radio broadcast service of a particular frequency.

In the same way as described above, the history of determination results or associated responses of the user is stored separately and used later in creating a future situation analysis model.

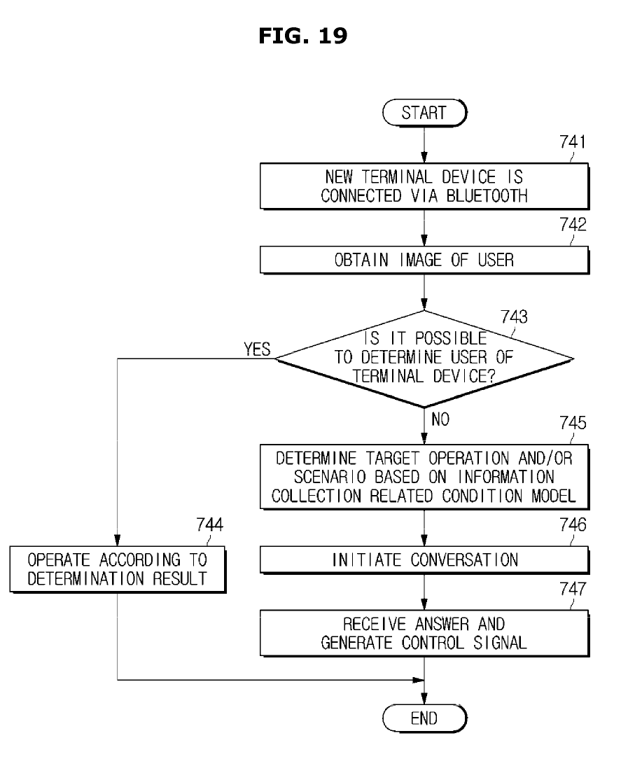

FIG. 19 is a flowchart illustrating a method to initiate a conversation based on the start of operation of a device equipped in a vehicle, according to embodiments of the present disclosure. In FIG. 19, an example of a process of initiating a conversation in response to a connection of a new terminal device is shown, if the situation-based conversation apparatus is a vehicle.

If the terminal device is connected to the short-range communication module of the vehicle through the bluetooth, the short-range communication module outputs an electric signal in response to the connection of the terminal device, in 741. In this case, the electric signal output in response to the connection of the terminal device may be used as the situation information.

An image of the interior of the vehicle including at least one user is obtained at the same time as or at a different time from the connection between the terminal device and the vehicle, in 742. Obtaining the image may be performed before the Bluetooth connection between the terminal device and the vehicle. An image of the at least one user may be used to identify who the driver is.

If the connected terminal device is one having a history of being connected before, and the user of the terminal device may be determined, in 743, connection is made between the terminal device and the situation-based conversation initiating apparatus based on the determination result without an extra registration procedure.

On the contrary, if the connected terminal device is a new one having no history of being connected before, and the user of the terminal device may not be determined in 743, information indicating that the terminal device is not identifiable to the user may be used as the situation information and extracted as the context data as well.

A target operation and/or scenario is determined based on the situation analysis model regarding registration of the terminal device, in 745. In this case, as a result of using the situation analysis model, if a result is obtained that a driver is typically the person who connects the terminal device, the target operation may be determined to be confirming and determining that the newly connected terminal device is owned by the driver, and if the driver is identified to be a particular person, the target operation may be determined to be confirming and determining that the newly connected terminal device is owned by the particular person.

Once the target operation and/or scenario is determined, a corresponding conversation starter, i.e., a conversation starter asking if the currently connected terminal device is owned by the driver is created, and the conversation starter is output for the vehicle and the user to start a conversation, in 746. The determination result may be added to the history information and used later in creating a future situation model analysis model.

Once a response is received from the user, the situation-based conversation initiating apparatus may in response register the new terminal device as the driver's terminal device. If the new terminal device is not owned by the driver, a message requesting information about the owner of the new terminal device may be output.

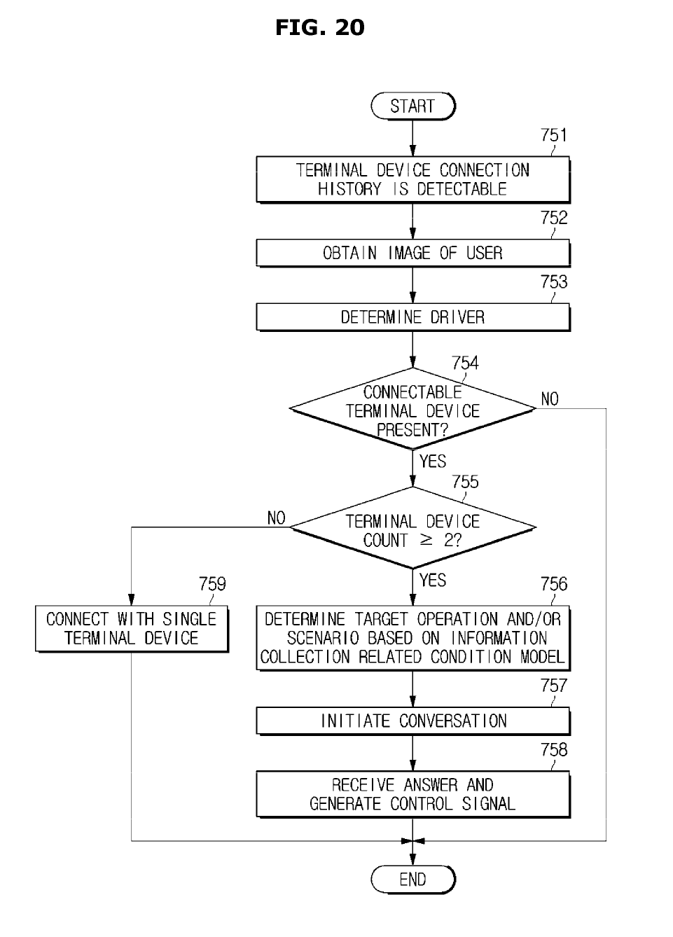

FIG. 20 is another flowchart illustrating a method to initiate a conversation based on the start of operation of a device equipped in a vehicle, according to embodiments of the present disclosure. An example of a process of initiating a conversation for wired or wireless connection between the driver's terminal device among connectable terminal devices and the vehicle is shown, if the situation-based conversation apparatus is the vehicle.

As shown in FIG. 20, if the terminal device has a history of being connected before, and thus the connection history of the terminal device is detectable, in 751, the vehicle obtains an image of the user inside the vehicle, i.e., the driver and the passenger, as needed, in 752, and analyze the image to determine who the driver of the vehicle is, in 753.

Subsequently, the vehicle may determine whether there is a connectable terminal device, using a cable or a wireless communication network (e.g., Bluetooth), in 754. If there is no connectable terminal device, operation for connection to a terminal device is stopped, in 754.

If there is a connectable terminal device, in 754, and the number of connectable terminal devices is less than 2 (i.e., there is one connectable terminal device), the single connectable device and the vehicle are connected, in 759. In this case, the vehicle may ask the user whether to connect the terminal device, or create a conversation starter about whether to connect the terminal device based on a situation analysis model provided separately.

If there are a plurality of target terminals, a target operation and/or scenario is determined based on the situation analysis model, in 756. Specifically, it is determined based on the situation analysis model which terminal device is to be connected to the vehicle. For example, context data indicating that there are a plurality of terminal devices may be input to the situation analysis model, which may in response, output a result that the driver's terminal is mainly connected to the vehicle.

Accordingly, a conversation starter asking whether to connect the driver's terminal device and the vehicle via a cable or over a wireless communication network is created and output through a voice output or a display. A conversation is then initiated between the vehicle and the user, in 757.

Once the user's response is received, a corresponding control signal is generated, and the vehicle performs an operation corresponding to the target operation, in 758. For example, if the user says yes to a suggestion provided by the conversation starter, operation of connecting the driver's terminal device and the vehicle is performed, and on the other hand, if the user says no to the suggestion, the operation of connecting the driver's terminal device and the vehicle is stopped.

The situation-based conversation initiating method may also be applied to a method for controlling a vehicle as it is or through partial modification According to embodiments of the present disclosure, the situation-based conversation initiating apparatus, system, vehicle, and method described hereinabove enable a surrounding situation to be recognized by analyzing various obtainable data, and a conversation with the user may be initiated based on the recognized situation.

Furthermore, a suitable and necessary operation of the vehicle may be determined based on various kinds of information obtained in a vehicle driving situation, and the vehicle may lead a conversation to provide the user with the determined operation in the form of recommendation or warning, thereby increasing safety and convenience of driving.

Furthermore, the driver may pay relatively less attention to the surrounding situation, which may prevent or minimize the driver's distraction, and accordingly, the driver may focus more on his/her driving, thereby increasing the safety of driving.

While the contents of the present disclosure have been described in connection with what is presently considered to be exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A situation-based conversation initiating apparatus in a vehicle, the situation-based conversation initiating apparatus comprising:
a situation information collector including a plurality of sensors disposed within the vehicle configured to collect situation information;
a processor configured to determine context data based on the situation information, determine a target operation based on the context data and a situation analysis model, and generate speaking content to be output based on the determined target operation; and
an output device configured to visually or audibly output the speaking content.

2. The situation-based conversation initiating apparatus of claim 1, wherein the processor is further configured to perform learning based on a user's usage history or a history of prior target operations, and create the situation analysis model based on a result of the learning.

3. The situation-based conversation initiating apparatus of claim 2, wherein the processor is further configured to perform at least one of rule-based learning and model-based learning and create the situation analysis model based on a result of the at least one of rule-based learning and model-based learning.

4. The situation-based conversation initiating apparatus of claim 1, wherein:
the situation information collector is further configured to collect a plurality of pieces of situation information, and
the processor is further configured to extract at least two correlated pieces of context data among the plurality of pieces of situation information, and determine the target operation based on the at least two pieces of context data and the situation analysis model.

5. The situation-based conversation initiating apparatus of claim 1, wherein the processor is further configured to determine an operation scenario of an operation entity corresponding to the target operation based on the determined target operation.

6. The situation-based conversation initiating apparatus of claim 5, wherein:
the operation entity includes at least one application, and
the processor is further configured to execute the at least one application and change a setting of the at least one application based on an operation of the determined target operation.

7. The situation-based conversation initiating apparatus of claim 1, wherein the situation information includes at least one of: a user's action, a user's action pattern, a driving state of the vehicle, a surrounding situation of the vehicle, a current time and location of the vehicle, a status or operation of a device installed in the vehicle, information received from an external source through a communication network, and information obtained from the user or the processor.

8. The situation-based conversation initiating apparatus of claim 1, wherein the processor is further configured to initiate the determining of the context data based on the situation information when a predefined event occurs.

9. The situation-based conversation initiating apparatus of claim 8, wherein the predefined event includes at least one of: a user's action, a change of status of the vehicle, a change in driving situation, an arrival of a particular time, a change of location, a change of setting information, a change of situation inside the vehicle, and a change of processing of a peripheral device.

10. The situation-based conversation initiating apparatus of claim 1, further comprising:
a voice receiver configured to receive a user's voice after the speaking content is output,
wherein the processor is further configured to analyze the user's voice and generate a control signal for the target operation based on the analyzed voice.

11. A situation-based conversation initiating method in a vehicle, the situation-based conversation initiating method comprising:
collecting situation information using a plurality of sensors disposed within the vehicle;
determining context data based on the situation information;
determining a target operation based on the context data and a situation analysis model;
generating speaking content to be output based on the determined target operation; and
visually or audibly outputting the speaking content using an output device.

12. The situation-based conversation initiating method of claim 11, further comprising:
storing a user's usage history or a history of prior target operations;
performing learning based on the user's usage history or the history of prior target operations; and
creating the situation analysis model based on a result of the learning.

13. The situation-based conversation initiating method of claim 11, wherein the performing of learning comprises performing at least one of rule-based learning and model-based learning.

14. The situation-based conversation initiating method of claim 11, wherein:
the collecting of the situation information comprises collecting a plurality of pieces of situation information, and
the determining of the context data comprises extracting at least two correlated pieces of context data among the plurality of pieces of situation information.

15. The situation-based conversation initiating method of claim 11, further comprising determining an operation scenario of an operation entity corresponding to the target operation based on the determined target operation.

16. The situation-based conversation initiating method of claim 15, wherein:
the operation entity includes at least one application, and
the determining of the operation scenario comprises executing the at least one application, and changing a setting of the at least one application based on an operation of the determined target operation.

17. The situation-based conversation initiating method of claim 11, wherein the situation information includes at least one of: a user's action, a user's action pattern, a driving state of the vehicle, a surrounding situation of the vehicle, a current time and location of the vehicle, a status or operation of a device installed in the vehicle, information received from an external source through a communication network, and information obtained from the user.

18. The situation-based conversation initiating method of claim 11, further comprising initiating the determining of the context data based on the situation information when a predefined event occurs.

19. The situation-based conversation initiating method of claim 18, wherein the predefined event includes at least one of: a user's action, a change of status of the vehicle, a change in driving situation, an arrival of a particular time, a change of location, a change of setting information, a change of situation inside the vehicle, and a change of processing of a peripheral device.

20. The situation-based conversation initiating method of claim 11, further comprising:
receiving a user's voice after the speaking content is output;
analyzing the user's voice; and
generating a control signal for the target operation based on the analyzed voice.

21. A vehicle comprising:
a situation information collector including a plurality of sensors disposed within the vehicle configured to collect situation information;
a processor configured to determine context data based on the situation information, determine a target operation based on the context data and a situation analysis model, and generate speaking content to be output based on the determined target operation; and
an output device configured to visually or audibly output the speaking content.
